(19) United States
(12) Patent Application Publication
(10) Pub. No.: US 2025/0285325 A1
(43) Pub. Date: Sep. 11, 2025

(54) Metric Relative Pose from Metric Correspondences

(71) Applicant: Niantic, Inc., San Francisco, CA (US)

(72) Inventors: Axel Barroso-Laguna, London (GB); Sowmya Munukutla, Sunnyvale, CA (US); Victor Adrian Prisacariu, Oxford (GB); Eric Brachmann, Hanover (DE)

(21) Appl. No.: 19/067,694

(22) Filed: Feb. 28, 2025

Related U.S. Application Data
(60) Provisional application No. 63/561,724, filed on Mar. 5, 2024.

(51) Int. Cl. G06T 7/73; G06T 7/50; G06T 19/20; G06V 10/44

(52) U.S. Cl. CPC G06T 7/73; G06T 7/50; G06T 19/20; G06V 10/44; G06T 2207/20084; G06T 2219/2016

(57) ABSTRACT

A method for determining a metric relative pose between a target image and a reference image is disclosed. The method includes receiving the target image depicting a scene captured by a camera assembly of a client device. The method includes applying a machine-learning model to the target image to determine a metric relative pose between the target image and a reference image, wherein the metric relative pose represents a transformation from a pose of the reference image to a pose of the target image that is scaled to physical dimensions of the scene. The machine-learning model may include a keypoint network for determining a keypoint distribution including the spatial coordinates of keypoints extracted from each image. The machine-learning model may establish correspondences between the keypoint distribution of the target image and the keypoint distribution of the reference image. Based on the identified correspondences, the machine-learning model may regress the metric relative pose. With the metric relative pose, augmented reality content may be generated and displayed informed by the physical dimensions of the scene described by the metric relative pose.

### CROSS-REFERENCE TO RELATED APPLICATIONS

This application claims the benefit of and priority to U.S. Provisional Application No. 63/561,724 filed on Mar. 5, 2024, which is incorporated by reference in its entirety.

### BACKGROUND

### 1. Technical Field

The subject matter described relates generally to pose determination, and, in particular, to determining a metric relative pose between two images of a scene without the need for independently measured depth information.

### 2. Problem

There is much interest in a range of applications for determining the relative pose between two images. That is, to determine the relative location and orientation of the camera (or cameras) at the times each image in a pair was captured. A common problem that arises with many existing approaches is that the determined relative pose is not scaled to the real world. In other words, while the relative distance between each camera and an object can be determined, the pose model provides no information as to whether the object is, for example, one meter from the first camera and two meters from the second camera or a hundred meters from the first camera and two hundred meters from the second camera. In the case of using the relative pose to provide augmented reality (AR) content, this is particularly problematic because the system cannot know the correct scale at which to display AR objects. For example, a virtual human should appear to be approximately the same size as a real human, but without knowing the distance between the camera and the position in the scene at which the virtual human will be rendered, it is impossible to know how large the human should be relative to physical objects in the scene. Some existing systems rely on separately captured depth data (e.g., from a LiDAR sensor) to address this problem. However, for many scenes and devices, depth data is either not available or difficult to obtain.

Moreover, training of a relative pose prediction model typically requires contextual information to guide the training process. For example, some methodologies split keypoint detection from depth estimation, as depth estimation models perform poorly in areas with depth discontinuities whereas the keypoint detection thrives off such areas. However, to train the depth estimation model, depth information from the training images is generally required. In other examples, some methodologies require inertial measurement unit (IMU) data paired with the image data to train a model to determine scaled dimensions of the relative poses. If these such contextual clues are unavailable, the models can't be robustly trained.

### SUMMARY

The present disclosure describes a solution to the above and other problems. In various embodiments, given two images, the relative camera pose between them is estimated by establishing image-to-image correspondences in three dimensions (3D). This approach uses a keypoint matching pipeline that is able to predict metric (scaled) correspondences in 3D camera space using a trained model (e.g., a neural network). By learning to match 3D coordinates across images, the model can infer the metric relative pose without depth measurements. The metric relative pose includes information on metric distances of objects in the scene (e.g., using the Metric system, or the United States customary system) in addition to pose of the camera. Depth measurements are also not required for training, nor are scene reconstructions or image overlap information. Rather, the model is trained in a supervised manner using pairs of images and their relative poses.

### BRIEF DESCRIPTION OF THE DRAWINGS

FIG. 1 depicts a representation of a virtual world having a geography that parallels the real world, according to one embodiment.

FIG. 2 depicts an exemplary game interface of a parallel reality game, according to one embodiment.

FIG. 3 is a block diagram of a networked computing environment suitable for providing two-view geometry scoring, according to one embodiment.

FIG. 4 is an illustrative flowchart of deployment of a metric relative pose model, according to one or more embodiments.

FIG. 5 illustrates an example architecture of a keypoint network, according to one or more embodiments.

FIG. 6 is a process flowchart describing the process of training a metric relative pose model, according to one or more embodiments.

FIG. 7 is a process flowchart describing the process of deployment of the metric relative pose model to predict a metric relative pose between a reference image and a target image, according to one or more embodiments.

FIG. 8 illustrates an example computer system suitable for use in the networked computing environment of FIG. 1, according to one embodiment.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. The subject matter described is applicable in other situations where determining the relative pose between two images of a scene is desirable. In addition, the inherent flexibility of computer-based systems allows for a great variety of possible configurations, combinations, and divisions of tasks and functionality between and among the components of the system.

### EXAMPLE LOCATION-BASED PARALLEL REALITY GAME

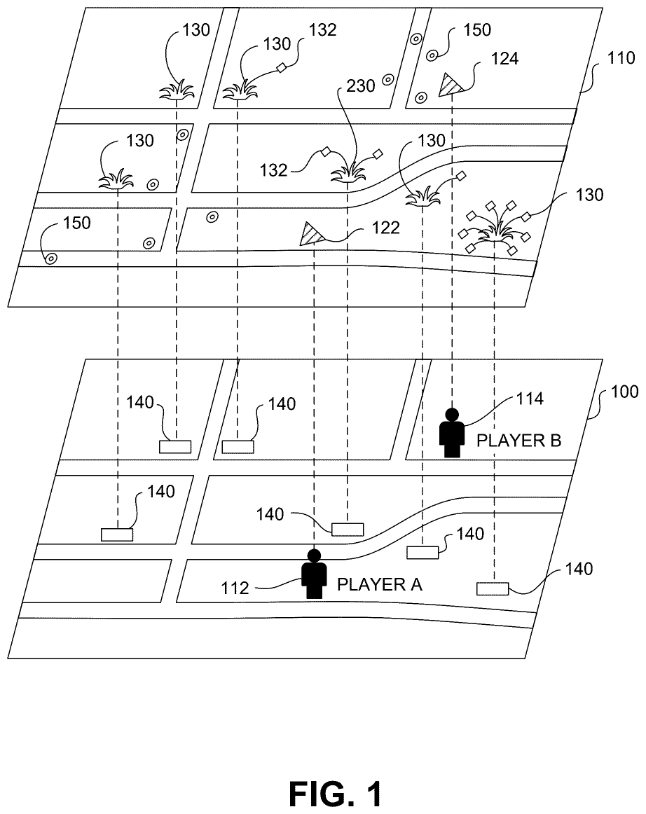

FIG. 1 is a conceptual diagram of a virtual world 110 that parallels the real world 100. The virtual world 110 can act as the game board for players of a parallel reality game. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A player's position in the virtual world 110 corresponds to the player's position in the real world 100. For instance, player A located at position 112 in the real world 100 has a corresponding position 122 in the virtual world 110. Similarly, player B located at position 114 in the real world 100 has a corresponding position 124 in the virtual world 110. As the players move about in a range of geographic coordinates in the real world 100, the players also move about in the range of coordinates defining the virtual space in the virtual world 110. In particular, a positioning system (e.g., a GPS system, a localization system, or both) associated with a mobile computing device carried by the player can be used to track a player's position as the player navigates the range of geographic coordinates in the real world 100. Data associated with the player's position in the real world 100 is used to update the player's position in the corresponding range of coordinates defining the virtual space in the virtual world 110. In this manner, players can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

The location-based game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to landmarks, geographic locations, or objects 140 in the real world 100. The real-world landmarks or objects 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the landmark or geographic locations 140 linked to the virtual elements 130 in the real world and performs any necessary interactions (as defined by the game's rules) with the virtual elements 130 in the virtual world 110. For example, player A may have to travel to a landmark 140 in the real world 100 to interact with or capture a virtual element 130 linked with that particular landmark 140. The interaction with the virtual element 130 can require action in the real world, such as taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g. weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

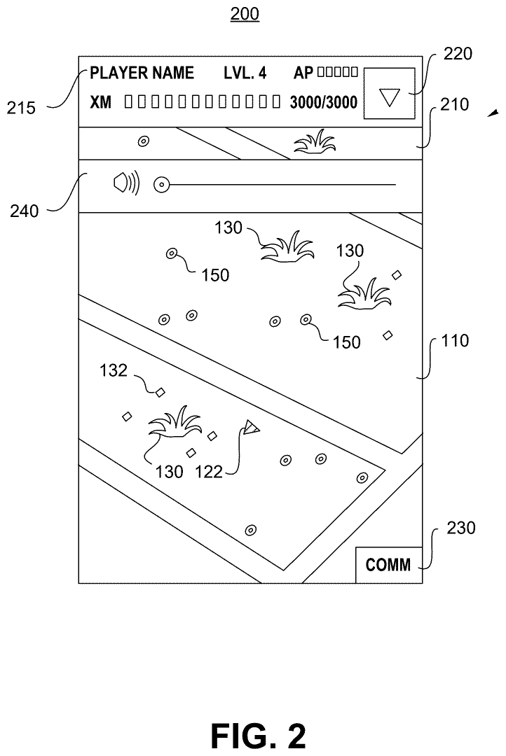

FIG. 2 depicts one embodiment of a game interface 200 that can be presented (e.g., on a player's smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device around in the real world. For instance, a player can play the game by accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### EXAMPLE GAMING SYSTEM

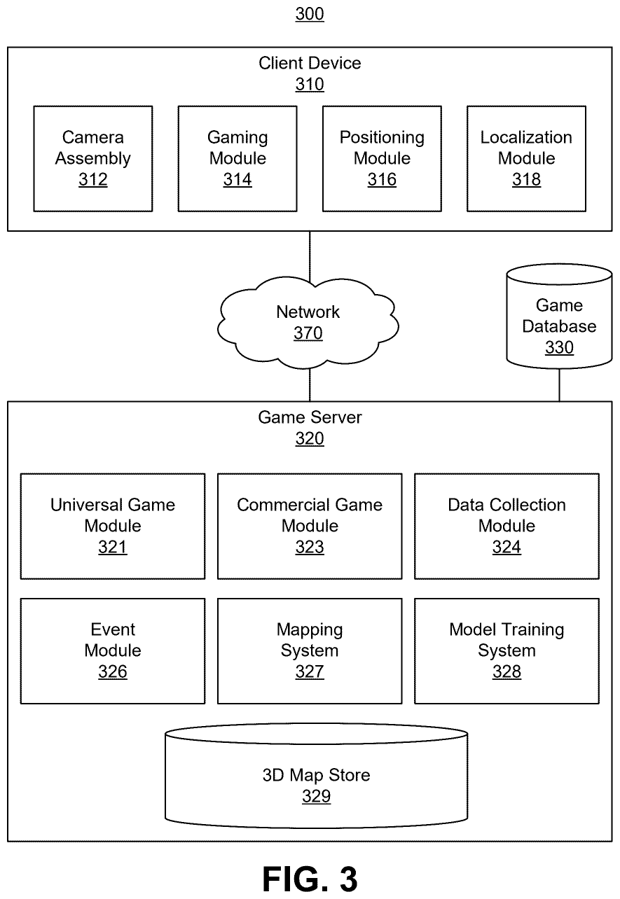

FIG. 3 illustrates one embodiment of a networked computing environment 300. The networked computing environment 300 uses a client-server architecture, where a game server 320 communicates with a client device 310 over a network 370 to provide a parallel reality game to a player at the client device 310. The networked computing environment 300 also may include other external systems such as sponsor/advertiser systems or business systems. Although only one client device 310 is shown in FIG. 3, any number of client devices 310 or other external systems may be connected to the game server 320 over the network 370. Furthermore, the networked computing environment 300 may contain different or additional elements and functionality may be distributed between the client device 310 and the server 320 in different manners than described below.

The networked computing environment 300 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 310 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 310.

A client device 310 can be any portable computing device capable for use by a player to interface with the game server 320. For instance, a client device 310 is preferably a portable wireless device that can be carried by a player, such as a smartphone, portable gaming device, augmented reality (AR) headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle with a built-in computing device.

The client device 310 communicates with the game server 320 to provide sensory data of a physical environment. In one embodiment, the client device 310 includes a camera assembly 312, a gaming module 314, positioning module 316, and localization module 318. The client device 310 also includes a network interface (not shown) for providing communications over the network 370. In various embodiments, the client device 310 may include different or additional components, such as additional sensors, display, and software modules, etc.

The camera assembly 312 includes one or more cameras which can capture image data. The cameras capture image data describing a scene of the environment surrounding the client device 310 with a particular pose (the location and orientation of the camera within the environment). The camera assembly 312 may use a variety of photo sensors with varying color capture ranges and varying capture rates. Similarly, the camera assembly 312 may include cameras with a range of different lenses, such as a wide-angle lens or a telephoto lens. The camera assembly 312 may be configured to capture single images or multiple images as frames of a video.

The client device 310 may also include additional sensors for collecting data regarding the environment surrounding the client device, such as movement sensors, accelerometers, gyroscopes, barometers, thermometers, light sensors, microphones, etc. The image data captured by the camera assembly 312 can be appended with metadata describing other information about the image data, such as additional sensory data (e.g. temperature, brightness of environment, air pressure, location, pose etc.) or capture data (e.g. exposure length, shutter speed, focal length, capture time, etc.).

The gaming module 314 provides a player with an interface to participate in the parallel reality game. The game server 320 transmits game data over the network 370 to the client device 310 for use by the gaming module 314 to provide a local version of the game to a player at locations remote from the game server. In one embodiment, the gaming module 314 presents a user interface on a display of the client device 310 that depicts a virtual world (e.g. renders imagery of the virtual world) and allows a user to interact with the virtual world to perform various game objectives. In some embodiments, the gaming module 314 presents images of the real world (e.g., captured by the camera assembly 312) augmented with virtual elements from the parallel reality game. In these embodiments, the gaming module 314 may generate or adjust virtual content according to other information received from other components of the client device 310. For example, the gaming module 314 may adjust a virtual object to be displayed on the user interface according to a depth map of the scene captured in the image data.

The gaming module 314 can also control various other outputs to allow a player to interact with the game without requiring the player to view a display screen. For instance, the gaming module 314 can control various audio, vibratory, or other notifications that allow the player to play the game without looking at the display screen.

The positioning module 316 can be any device or circuitry for determining the position of the client device 310. For example, the positioning module 316 can determine actual or relative position by using a satellite navigation positioning system (e.g. a GPS system, a Galileo positioning system, the Global Navigation satellite system (GLONASS), the BeiDou Satellite Navigation and Positioning system), an inertial navigation system, a dead reckoning system, IP address analysis, triangulation and/or proximity to cellular towers or Wi-Fi hotspots, or other suitable techniques.

As the player moves around with the client device 310 in the real world, the positioning module 316 tracks the position of the player and provides the player position information to the gaming module 314. The gaming module 314 updates the player position in the virtual world associated with the game based on the actual position of the player in the real world. Thus, a player can interact with the virtual world simply by carrying or transporting the client device 310 in the real world. In particular, the location of the player in the virtual world can correspond to the location of the player in the real world. The gaming module 314 can provide player position information to the game server 320 over the network 370. In response, the game server 320 may enact various techniques to verify the location of the client device 310 to prevent cheaters from spoofing their locations. It should be understood that location information associated with a player is utilized only if permission is granted after the player has been notified that location information of the player is to be accessed and how the location information is to be utilized in the context of the game (e.g. to update player position in the virtual world). In addition, any location information associated with players is stored and maintained in a manner to protect player privacy.

The localization module 318 provides an additional or alternative way to determine the location of the client device 310. In one or more embodiments, the localization module 318 applies a localization model to determine a pose for an image. The pose provides information on a position and an orientation of the camera that captured the image. The localization model may be configured to input additional information relating to the image in determining the pose for the image, e.g., camera intrinsic parameters, other images captured by the same camera in temporal proximity (e.g., frames of a video), etc.

In one or more embodiments, the localization module 318 applies a metric relative pose model as an embodiment of a localization model. The metric relative pose model inputs an image (e.g., captured by the camera assembly 312) to determine the pose of the image (e.g., the camera assembly 312 of the client device 310) relative to a reference image. The metric relative pose model outputs a metric relative pose for an image captured by the camera assembly 312 to one or more reference images. The references images may be one or more previously captured images of the scene that have been selected for use in localization, other images of the scene previously captured by the camera assembly 312 of the client device 310, other images of the scene captured by other client devices, or any combination thereof. The metric relative pose is a relative pose between a target image and a reference image, i.e., a translation and a rotation to transform the camera pose from the reference image to the camera pose for the target image. The translation and the rotation may be metered, i.e., providing information on relative scale between the two images.

In one or more embodiments, the metric relative pose may be used in generation of AR content for the client device 310, e.g., as part of a gaming experience, or as part of an AR experience. For example, a virtual element may be generated with a scale based on the metric relative pose. In one or more embodiments, the metric relative pose may enable a shared, map-free AR experiences for multiple users at approximately the same location in which AR content can be scaled to the environment without the need for separately captured depth data. For example, the gaming module 314 may leverage the metric relative pose output by the metric relative pose model to generate content at appropriate scales for each of the client devices 310 connected to the shared AR experience. As a relative position between the client devices 310 and the virtual element changes, the appearance (e.g., a scale of the virtual element) can by dynamically updated based on real-time metric relative pose determinations by the metric relative pose model. In one or more embodiments, the metric relative pose may be used in navigation. For example, the gaming module 314 may generate navigation instructions to navigate a user of the client device 310 to a particular position, based on their current position, as determined by the metric relative pose. In other examples, navigation instructions may be generated for navigation of an autonomous agent.

The game server 320 includes one or more computing devices that provide game functionality to the client device 310. The game server 320 can include or be in communication with a game database 330. The game database 330 stores game data used in the parallel reality game to be served or provided to the client device 310 over the network 370.

The game data stored in the game database 330 can include: (1) data associated with the virtual world in the parallel reality game (e.g. imagery data used to render the virtual world on a display device, geographic coordinates of locations in the virtual world, etc.); (2) data associated with players of the parallel reality game (e.g. player profiles including but not limited to player information, player experience level, player currency, current player positions in the virtual world/real world, player energy level, player preferences, team information, faction information, etc.); (3) data associated with game objectives (e.g. data associated with current game objectives, status of game objectives, past game objectives, future game objectives, desired game objectives, etc.); (4) data associated with virtual elements in the virtual world (e.g. positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g. location of real-world objects/landmarks, description of real-world objects/landmarks, relevance of virtual elements linked to real-world objects, etc.); (6) game status (e.g. current number of players, current status of game objectives, player leaderboard, etc.); (7) data associated with player actions/input (e.g. current player positions, past player positions, player moves, player input, player queries, player communications, etc.); or (8) any other data used, related to, or obtained during implementation of the parallel reality game. The game data stored in the game database 330 can be populated either offline or in real time by system administrators or by data received from users (e.g., players), such as from a client device 310 over the network 370.

In one embodiment, the game server 320 is configured to receive requests for game data from a client device 310 (for instance via remote procedure calls (RPCs)) and to respond to those requests via the network 370. The game server 320 can encode game data in one or more data files and provide the data files to the client device 310. In addition, the game server 320 can be configured to receive game data (e.g. player positions, player actions, player input, etc.) from a client device 310 via the network 370. The client device 310 can be configured to periodically send player input and other updates to the game server 320, which the game server uses to update game data in the game database 330 to reflect any and all changed conditions for the game.

In the embodiment shown in FIG. 3, the game server 320 includes a universal game module 322, a commercial game module 323, a data collection module 324, an event module 326, a mapping system 327, a model training system 328, and a 3D map store 329. As mentioned above, the game server 320 interacts with a game database 330 that may be part of the game server or accessed remotely (e.g., the game database 330 may be a distributed database accessed via the network 370). In other embodiments, the game server 320 contains different or additional elements. In addition, the functions may be distributed among the elements in a different manner than described.

The universal game module 322 hosts an instance of the parallel reality game for a set of players (e.g., all players of the parallel reality game) and acts as the authoritative source for the current status of the parallel reality game for the set of players. As the host, the universal game module 322 generates game content for presentation to players (e.g., via their respective client devices 310). The universal game module 322 may access the game database 330 to retrieve or store game data when hosting the parallel reality game. The universal game module 322 may also receive game data from client devices 310 (e.g. depth information, player input, player position, player actions, landmark information, etc.) and incorporates the game data received into the overall parallel reality game for the entire set of players of the parallel reality game. The universal game module 322 can also manage the delivery of game data to the client device 310 over the network 370. In some embodiments, the universal game module 322 also governs security aspects of the interaction of the client device 310 with the parallel reality game, such as securing connections between the client device and the game server 320, establishing connections between various client devices, or verifying the location of the various client devices 310 to prevent players cheating by spoofing their location.

The commercial game module 323 can be separate from or a part of the universal game module 322. The commercial game module 323 can manage the inclusion of various game features within the parallel reality game that are linked with a commercial activity in the real world. For instance, the commercial game module 323 can receive requests from external systems such as sponsors/advertisers, businesses, or other entities over the network 370 to include game features linked with commercial activity in the real world. The commercial game module 323 can then arrange for the inclusion of these game features in the parallel reality game on confirming the linked commercial activity has occurred. For example, if a business pays the provider of the parallel reality game an agreed upon amount, a virtual object identifying the business may appear in the parallel reality game at a virtual location corresponding to a real-world location of the business (e.g., a store or restaurant).

The data collection module 324 can be separate from or a part of the universal game module 322. The data collection module 324 can manage the inclusion of various game features within the parallel reality game that are linked with a data collection activity in the real world. For instance, the data collection module 324 can modify game data stored in the game database 330 to include game features linked with data collection activity in the parallel reality game. The data collection module 324 can also analyze data collected by players pursuant to the data collection activity and provide the data for access by various platforms.

The event module 326 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The mapping system 327 generates a 3D map of a geographical region based on a set of images. The 3D map may be a point cloud, polygon mesh, or any other suitable representation of the 3D geometry of the geographical region. The 3D map may include semantic labels providing additional contextual information, such as identifying objects tables, chairs, clocks, lampposts, trees, etc.), materials (concrete, water, brick, grass, etc.), or game properties (e.g., traversable by characters, suitable for certain in-game actions, etc.). In one embodiment, the mapping system 327 stores the 3D map along with any semantic/contextual information in the 3D map store 329. The 3D map may be stored in the 3D map store 329 in conjunction with location information (e.g., GPS coordinates of the center of the 3D map, a ringfence defining the extent of the 3D map, or the like). Thus, the game server 320 can provide the 3D map to client devices 310 that provide location data indicating they are within or near the geographic area covered by the 3D map. In one or more embodiments, the mapping system 327 may fuse information from a plurality of images of a scene, e.g., leveraging the metric relative pose output by the metric relative pose model, to inform distances between key points in the scene and captured by the images.

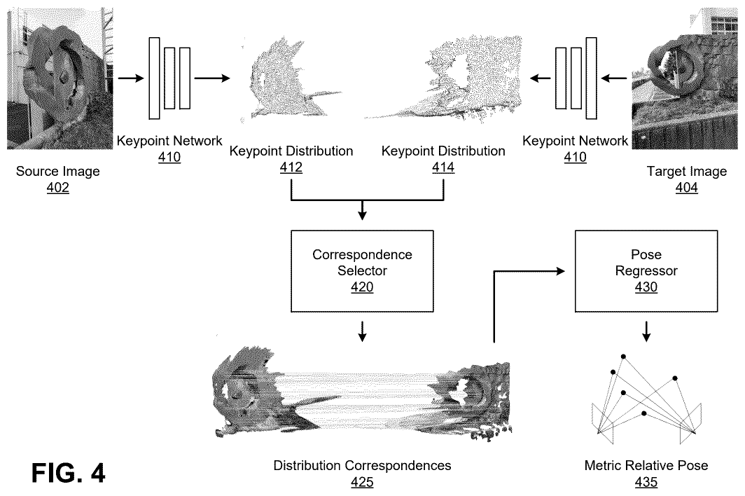

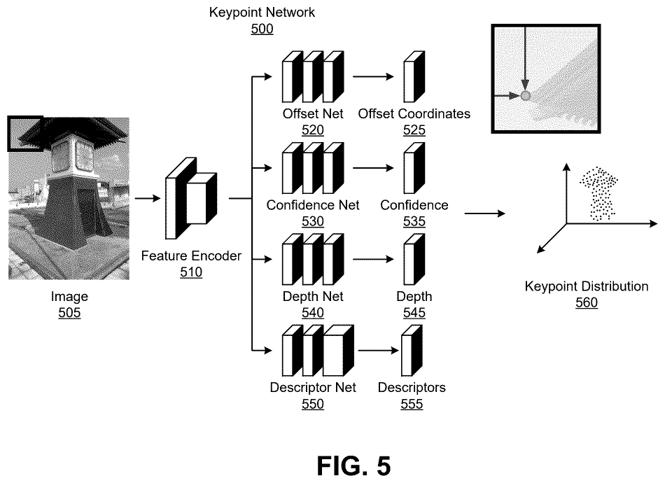

The model training system 328 may train models for use by other components of the networked computing environment 300. For example, in one embodiment, the model training system 328 may train the metric relative pose model for use by the localization module 318 of one or more client devices 310. Although the model training system 328 is shown as part of the game server 320 for convenience, in some embodiments, the model training system 328 may be a distinct entity, separate from the game server 320. Training of the metric relative pose model is further described in FIGS. 4-5.

The network 370 can be any type of communications network, such as a local area network (e.g. intranet), wide area network (e.g. Internet), or some combination thereof. The network can also include a direct connection between a client device 310 and the game server 320. In general, communication between the game server 320 and a client device 310 can be carried via a network interface using any type of wired or wireless connection, using a variety of communication protocols (e.g. TCP/IP, HTTP, SMTP, FTP), encodings or formats (e.g. HTML, XML, JSON), or protection schemes (e.g. VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

### METRIC RELATIVE POSE ESTIMATION

FIG. 4 is an illustrative flowchart of deployment of a metric relative pose model, according to one or more embodiments. The metric relative pose model may include a keypoint network 410, a correspondence selector 420, and a pose regressor. The metric relative pose model may input two images, a reference image 402 and a target image 404 to output the metric relative pose transforming the camera pose for the reference image 402 to the camera pose for the target image 404, i.e., indicating a translation (e.g., in metered distance) and a rotation.

Each image is input into the keypoint network 410 to output a corresponding keypoint distribution. For example, the reference image 402 is input into the keypoint network 410 to output a keypoint distribution 412, and the target image 404 is input into the keypiont network 410 to output a keypoint distribution 414. The keypoint distribution maps keypoint features in each image into spatial coordinates (e.g., three degrees of freedom) in the image's own coordinate system. The architecture of the keypoint network 410 is further described in FIG. 5.

With the two keypoint distributions, a correspondence selector determines distribution correspondences, corresponding at least a subset of keypoints in the keypoint distribution 412 to at least a subset of keypoints in the keypoint distribution 414. The correspondence selector may leverage an algorithm that computes the likelihood of one keypoint in the keypoint distribution 412 corresponding to one keypoint in the keypoint distribution 414 based on their spatial coordinates. In some embodiments, the keypoint network 410 may further output a confidence and/or descriptor feature(s) for keypoints in the keypoint distribution. The algorithm may further select the distribution correspondences based on the confidence(s) and/or the descriptor feature(s).

A keypoint is characterized as three-dimensional (3D) spatial coordinates. The keypoint may be further characterized by the confidence and/or descriptor features. In one or more embodiments, to achieve the 3D spatial coordinates, the keypoint network 410 outputs the 2D coordinate of the keypoint within the image and a depth of the keypoint, both of which are used to project the keypoint into the 3D space. A correspondence links one keypoint from one keypoint distribution to one keypoint from another keypoint distribution.

In one or more embodiments, to determine the distribution correspondences, i.e., the entire set of correspondences between keypoints of the two keypoint distributions, the correspondence selector maximizes a total probability of sampling the keypoint correspondences, as a function of the descriptor matching and keypoint selection probabilities. The function may incorporate forward matching, the probability of selecting keypoint i in image I (reference image) and the probability of keypoint j in image I′ (target image) being the nearest neighbor of i in the 3D coordinate space, and backward matching, the probability of selecting keypoint j in image I′ and the probability of keypoint i in image I being the nearest neighbor of j in the 3D coordinate space. The total probability for the entire correspondence set may be defined as a matrix for each possible correspondence probability. The total probabilities may further factor in confidence output by the keypoint network 410.

In one or more embodiments, the nearest neighbor matching (i.e., the descriptor matching probability) represents the probability of two keypoints (in differing distributions) being mutual nearest neighbors, i.e., keypoint i matches keypoint j, and vice versa. A Softmax function may be applied over all the similarities of j for a fixed i:

P_{I→I′}(j|i)=Softmax(m(i,·)/θₘ)ⱼ

where m is the matrix defining all descriptor similarities and θₘ is the descriptor Softmax temperature. Before the Softmax operator, m is augmented with a single learnable dustbin parameter to allow unmatched keypoints to be assigned to it. The dustbin parameter is removed after the Softmax operator. A likewise probability is defined from I′-I in the backward matching probability.

With the distribution correspondences 425, the pose regressor 430 computes the metric relative pose 435. The pose regressor 430 may leverage a robust estimator, e.g., RANSAC, to compute the pose hypotheses from the distribution correspondences 425. The RANSAC layer may be differentiable, empowering backpropagation of a pose error to the keypoints and correspondences. The pose regressor estimates the metric relative pose that minimizes the square residual over the distribution correspondences 425 after transformation of one distribution to the other based on the estimated pose.

The pose regressor 430 may further leverage soft-inlier counting and refinement of pose hypotheses. The pose regressor 430 may compute a differentiable approximation of the inlier counting by replacing the hard threshold with a Sigmoid function. The soft-inlier counting is done over the complete set of correspondences, with a hyperparameter controlling the softness of the Sigmoid. The pose regressor 430 may then iteratively refine pose hypotheses with the correspondence inliers.

To train the metric relative pose model, a training system (e.g., the model training system 328) leverages a training dataset of image pairs with known relative poses between each image pair. Each image pair includes some overlapping information, e.g., captures the same object in the real-world. The relative pose may be a metric relative pose, with the translation between the two camera poses measured in metered distance. The training system may feed the training dataset through the metric relative pose model to predict a relative pose between each image pair. The training system may score the prediction by computing a loss between the predicted relative pose and the known relative pose, as ground truth. The training system may backpropagate the loss through the metric relative pose model, adjusting parameters of the model to minimize the loss. In some embodiments, the training system trains the metric relative pose model as a machine-learning model. In some embodiments, the training system trains the model end-to-end, adjusting parameters of each layer or submodel. In some embodiments, the training system may perform staged training, wherein each stage the system fixes one or more layers or submodels, while adjusting parameters of another layer or submodel. One advantage of the metric relative pose model is its simplicity. The metric relative pose model can estimate a metric relative pose between two images, without any other contextual information, e.g., without inertial measurement unit data, without depth information, etc.

FIG. 5 illustrates an example architecture of a keypoint network 500, according to one or more embodiments. The keypoint network 500 may be an embodiment of the keypoint network 410. The keypoint network 500 includes a feature encoder 510, an offset network 520, a confidence network 530, a depth network 540, and a descriptor network 550. In other embodiments, the keypoint network 500 may include additional, fewer, or different components than those listed herein.

The feature encoder 510 extracts features from the image 505 upstream of the four parallel networks. In some embodiments, the feature encoder 510 is a pre-trained encoder that divides an input image into patches, to output a feature vector per patch. The patches subdivide the image. In one or more embodiments, the patches are non-overlapping.

The output layers, i.e., the offset network 520, the confidence network 530, the depth network 540, and the descriptor network 550, process the feature map (i.e., the output of the feature encoder 510) to compute the 2D offset coordinates 525, the confidence 535, the depth 545, and the descriptors 555, respectively.

The outputs are fused into a keypoint distribution 560, including the collection of keypoints output by the keypoint network 500, defined by the offset coordinates 525, the confidence 535, the depth 545, and the descriptors 555.

### EXAMPLE METHODS

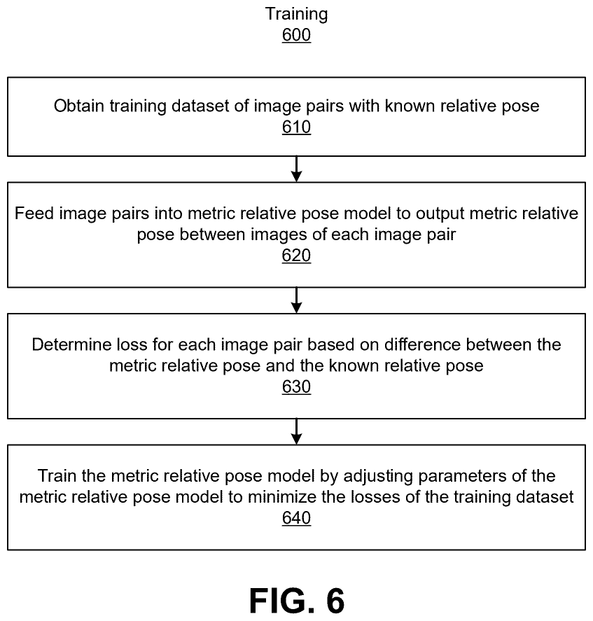

FIG. 6 is a process flowchart describing the process of training 600 a metric relative pose model, according to one or more embodiments. The process may be performed by a training system (e.g., the model training system 328 of FIG. 3), or any general computer system. The process may include additional, fewer, or different steps than those listed herein.

The training system obtains 610 a training dataset of image pairs with known relative poses. The training 600 can leverage image pairs with limited insight, e.g., without depth information, without inertial measurement unit data, without known correspondences, etc. Even with the limited insight, the training system can train the metric relative pose model to predict metric relative pose between two images. The image pairs may be captured by one or more camera assemblies. The images may include intrinsic parameters, e.g., focal length of the lens, principal point, pixel dimensions, skew, etc.

The training system feeds 620 the images pairs into the metric relative pose model to output a metric relative pose between images of each image pair. The metric relative pose model may have an architecture as embodied in FIG. 4, i.e., including a keypoint network, a correspondence selector, and a pose regressor. The keypoint network may have an architecture as embodied in FIG. 5, i.e., including a feature encoder with a plurality of output layers in parallel.

The training system determines 630 a loss for each image pair based on the difference between the metric relative pose and the known relative pose. The training system may compute the loss as a differential of the translation (i.e., between the two image poses) combined with a differential of the rotation (i.e., between the two image poses).

The training system trains 640 the metric relative pose model by adjusting parameters of the metric relative pose model to minimize the losses of the training dataset. The training system may train the metric relative pose model as a machine-learning model. The training system may train the model end-to-end, adjusting parameters of each layer or submodel. For example, the training system may concurrently train the keypoint network, the correspondence selector, and the pose regressor. In other embodiments, the training system may perform staged training, i.e., wherein the training system trains one or more layers or submodels in each stage, while fixing other layers or submodels.

In one or more embodiments, the training 600 may entail a recursive paradigm to refine the model through iterations. In such embodiments, the training system may compute intermediary losses for some layer of the model. The training system may, through some number of iterations, refine the layer (i.e., adjusting parameters of that layer) to minimize the intermediary losses.

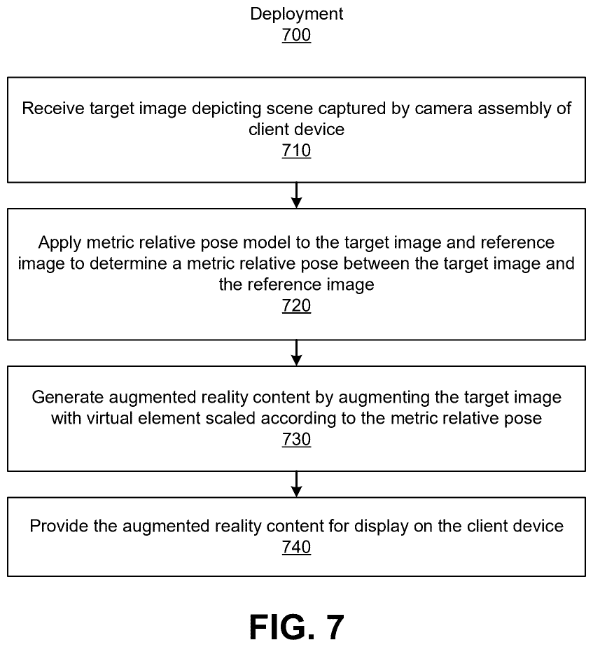

FIG. 7 is a process flowchart describing the process of deployment 700 of the metric relative pose model to predict a metric relative pose between a reference image and a target image, according to one or more embodiments. The process may be performed by a client device (e.g., the client device 310 of FIG. 3), a game server (e.g., the game server 320 of FIG. 3), or any general computer system. Although the remaining description describes the client device as performing the deployment 700 of the metric relative pose model, it can be understood that any other computer system may perform the process. The process may include additional, fewer, or different steps than those listed herein.

The client device receives 710 a target image depicting a scene captured by a camera assembly of the client device. The client device may instruct the camera assembly to capture the target image. In some embodiments, the client device is engaging in an augmented reality (AR) experience. As the camera assembly's live feed is captured, the client device presents the AR experience layered atop the live feed. In some embodiments, the game server hosts the AR experience. In such embodiments, the game server receives the live feed and augments the live feed with virtual content. In further embodiments, the AR experience may be a shared AR experience across a plurality of client devices.

The client device applies 720 a metric relative pose model to the target image and a reference image to determine a metric relative pose between the target image and the reference image. The metric relative pose model may be trained according to the training 600 of FIG. 6. The metric relative pose model may have an architecture as embodied in FIG. 4, i.e., including a keypoint network, a correspondence selector, and a pose regressor. The keypoint network may have an architecture as embodied in FIG. 5, i.e., including a feature encoder with a plurality of output layers in parallel. The reference image may be obtained from another client device, from a game server, etc.

In some embodiments, there may be multiple reference images of the same scene. In such embodiments, the client device may deploy the metric relative pose model to compute a metric relative pose between the target image and each reference image. The client device may fuse the relative poses when generating the augmented reality content. For example, the client device may determine the pose of the camera assembly relative to scene by fusing the plurality of relative poses. This may arise in the context of a shared AR experience by two or more players operating their own client devices. The metric relative pose may include scale of the scene, e.g., metric distances between image poses, metric distances between keypoints, etc. In some embodiments, the position of the reference image relative to the scene may be known, such that client device may compute the position of the target image relative to the scene, i.e., by translating from the reference image's pose to the target image's pose based on the predicted metric relative pose.

The client device generates 730 augmented reality (AR) content by augmenting the target image with a virtual element scaled according to the metric relative pose. The client device may scale the virtual element based on the understanding of the scale of the scene, i.e., the physical dimensions between points of interest in the scene. In embodiments with a shared AR experience, the virtual element may be scaled according to each client device's camera assembly relative pose. In some embodiments, the client device may dynamically generate the AR content as the client device moves or rotates around. As the client device moves or rotates around, the camera assembly may continuously capture image data. The client device may iteratively apply the metric relative pose model to determine an updated pose of the client device. As the pose is updated, the client device may dynamically adjust presentation of the virtual element, e.g., adjusting scale, adjusting perspective, adjusting occlusion or disocclusion, etc.

The client device provides 740 the augmented reality content for display on the client device. The client device may provide the AR content as part of an AR experience, as part of a game, etc. The AR experience may include functionality for the client device to engage with the AR content. For example, the virtual element may be interacted with based on proximity of the client device to the virtual position of the virtual element. This functionality may leverage the metric relative pose, i.e., the client device determines whether the client device position is within the proximity threshold to trigger interaction based on the metric relative pose (or information derivative from the metric relative pose).

### EXAMPLE COMPUTING SYSTEM

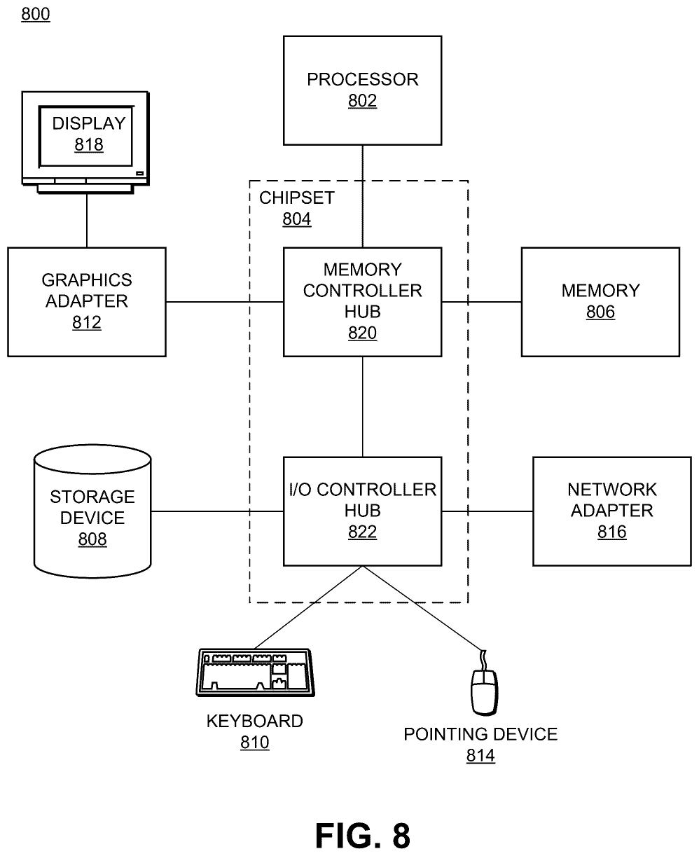

FIG. 8 is a block diagram of an example computer 800 suitable for use as a client device 310 or game server 320. The example computer 800 includes at least one processor 802 coupled to a chipset 804. References to a processor (or any other component of the computer 800) should be understood to refer to any one such component or combination of such components working cooperatively to provide the described functionality. The chipset 804 includes a memory controller hub 820 and an input/output (I/O) controller hub 822. A memory 806 and a graphics adapter 812 are coupled to the memory controller hub 820, and a display 818 is coupled to the graphics adapter 812. A storage device 808, keyboard 810, pointing device 814, and network adapter 816 are coupled to the I/O controller hub 822. Other embodiments of the computer 800 have different architectures.

In the embodiment shown in FIG. 8, the storage device 808 is a non-transitory computer-readable storage medium such as a hard drive, compact disk read-only memory (CD-ROM), DVD, or a solid-state memory device. The memory 806 holds instructions and data used by the processor 802. The pointing device 814 is a mouse, track ball, touch-screen, or other type of pointing device, and may be used in combination with the keyboard 810 (which may be an on-screen keyboard) to input data into the computer system 800. The graphics adapter 812 displays images and other information on the display 818. The network adapter 816 couples the computer system 800 to one or more computer networks, such as network 370.

The types of computers used by the entities of FIG. 3 can vary depending upon the embodiment and the processing power required by the entity. For example, the game server 320 might include multiple blade servers working together to provide the functionality described. Furthermore, the computers can lack some of the components described above, such as keyboards 810, graphics adapters 812, and displays 818.

### ADDITIONAL CONSIDERATIONS

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by any claims that ultimately issue.

What is claimed is:

1. A computer-implemented method comprising:
receiving a target image depicting a scene captured by a camera assembly of a client device;
applying a machine-learning model to the target image to determine a metric relative pose between the target image and a reference image, wherein the metric relative pose represents a transformation from a pose of the reference image to a pose of the target image that is scaled to physical dimensions of the scene;
generating augmented reality content by augmenting the target image with a virtual element scaled according to the physical dimensions of the scene described by the metric relative pose; and
providing the augmented reality content for display at the client device.

2. The computer-implemented method of claim 1, wherein applying the machine-learning model comprises:
inputting the target image into a neural network to output a first distribution of keypoints derived from the target image, wherein each keypoint includes spatial coordinates for a distinctive point in the target image;
inputting the reference image into the neural network to output a second distribution of keypoints derived from the reference image, wherein each keypoint includes spatial coordinates for a distinct point in the reference image;
determining a set of correspondences between keypoints in the first distribution and keypoints in the second distribution based on the spatial coordinates of the keypoints in the first distribution and the spatial coordinates of keypoints in the second distribution; and
determining the metric relative pose based on the set of correspondences.

3. The computer-implemented method of claim 2, wherein inputting the target image into the neural network comprises:
inputting the target image into a feature encoder of the neural network to output features for the target image;
inputting the features into a first output layer of the neural network to output two-dimensional offset coordinates in the image plane for each keypoint; and
inputting the features into a second output layer of the neural network to output a depth for each keypoint,
wherein the spatial coordinates for each keypoint are based on the two-dimensional offset coordinates output by the first output layer and the depth output by the second output layer.

4. The computer-implemented method of claim 3, wherein inputting the target image into the neural network further comprises:
inputting the features into a third output layer of the neural network to output descriptor features for the keypoint,
wherein determining the set of correspondences between keypoints in the first distribution and keypoints in the second distribution is further based on the descriptor features for the keypoints in the first distribution and the descriptor features for the keypoints in the second distribution.

5. The computer-implemented method of claim 2, wherein determining the set of correspondences between keypoints in the first distribution and keypoints in the second distribution comprises:
for each of a plurality of possible correspondences, determining a probability for the correspondence as a likelihood that one keypoint in the first distribution is a nearest neighbor to one keypoint in the second distribution; and
maximizing the probabilities across the possible correspondences to yield the set of correspondences.

6. The computer-implemented method of claim 2, wherein determining the metric relative pose based on the set of correspondences comprises implementing a random sample consensus (RANSAC) algorithm to regress metric relative pose from the set of correspondences.

7. The computer-implemented method of claim 1, wherein applying the machine-learning model to determine the metric relative pose between the target image and the reference image comprises outputting the metric relative pose comprising a translation in metric distance from the pose of the reference image to the pose of the target image.

8. The computer-implemented method of claim 1, wherein generating the augmented reality content comprises:
determining a position of the virtual element in the scene;
determining a metric distance between the position of the virtual element and the pose of the target image based on the metric relative pose; and
scaling the virtual element based on the metric distance.

9. The computer-implemented method of claim 8, wherein generating the augmented reality content further comprises:
determining a change in position of the virtual element to a second position;
determining a second metric distance between the second position of the virtual element and the pose of the target image based on the metric relative pose; and
adjusting a scale of the virtual element as the virtual element changes position to the second position.

10. The computer-implemented method of claim 1, further comprising:
receiving the reference image, the reference image captured by another camera assembly of another client device engaging in a shared augmented reality experience with the client device.

11. A non-transitory computer-readable storage medium storing instructions that, when executed by the computer processor, cause the computer processor to perform operations comprising:
receiving a target image depicting a scene captured by a camera assembly of a client device;
applying a machine-learning model to the target image to determine a metric relative pose between the target image and a reference image, wherein the metric relative pose represents a transformation from a pose of the reference image to a pose of the target image that is scaled to physical dimensions of the scene;
generating augmented reality content by augmenting the target image with a virtual element scaled according to the physical dimensions of the scene described by the metric relative pose; and
providing the augmented reality content for display at the client device.

12. The non-transitory computer-readable storage medium of claim 11, wherein applying the machine-learning model comprises:
inputting the target image into a neural network to output a first distribution of keypoints derived from the target image, wherein each keypoint includes spatial coordinates for a distinctive point in the target image;
inputting the reference image into the neural network to output a second distribution of keypoints derived from the reference image, wherein each keypoint includes spatial coordinates for a distinct point in the reference image;
determining a set of correspondences between keypoints in the first distribution and keypoints in the second distribution based on the spatial coordinates of the keypoints in the first distribution and the spatial coordinates of keypoints in the second distribution; and
determining the metric relative pose based on the set of correspondences.

13. The non-transitory computer-readable storage medium of claim 12, wherein inputting the target image into the neural network comprises:
inputting the target image into a feature encoder of the neural network to output features for the target image;
inputting the features into a first output layer of the neural network to output two-dimensional offset coordinates in the image plane for each keypoint; and
inputting the features into a second output layer of the neural network to output a depth for each keypoint,
wherein the spatial coordinates for each keypoint are based on the two-dimensional offset coordinates output by the first output layer and the depth output by the second output layer.

14. The non-transitory computer-readable storage medium of claim 13, wherein inputting the target image into the neural network further comprises:
inputting the features into a third output layer of the neural network to output descriptor features for the keypoint,
wherein determining the set of correspondences between keypoints in the first distribution and keypoints in the second distribution is further based on the descriptor features for the keypoints in the first distribution and the descriptor features for the keypoints in the second distribution.

15. The non-transitory computer-readable storage medium of claim 12, wherein determining the set of correspondences between keypoints in the first distribution and keypoints in the second distribution comprises:
for each of a plurality of possible correspondences, determining a probability for the correspondence as a likelihood that one keypoint in the first distribution is a nearest neighbor to one keypoint in the second distribution; and
maximizing the probabilities across the possible correspondences to yield the set of correspondences.

16. The non-transitory computer-readable storage medium of claim 12, wherein determining the metric relative pose based on the set of correspondences comprises implementing a random sample consensus (RANSAC) algorithm to regress metric relative pose from the set of correspondences.

17. The non-transitory computer-readable storage medium of claim 11, wherein applying the machine-learning model to determine the metric relative pose between the target image and the reference image comprises outputting the metric relative pose comprising a translation in metric distance from the pose of the reference image to the pose of the target image.

18. The non-transitory computer-readable storage medium of claim 11, wherein generating the augmented reality content comprises:
determining a position of the virtual element in the scene;
determining a metric distance between the position of the virtual element and the pose of the target image based on the metric relative pose; and
scaling the virtual element based on the metric distance.

19. The non-transitory computer-readable storage medium of claim 18, wherein generating the augmented reality content further comprises:
determining a change in position of the virtual element to a second position;
determining a second metric distance between the second position of the virtual element and the pose of the target image based on the metric relative pose; and
adjusting a scale of the virtual element as the virtual element changes position to the second position.

20. A device comprising:
a camera assembly configured to capture images;
an electronic display configured to display electronic visual content;
a computer processor; and
a non-transitory computer-readable storage medium storing instructions that, when executed by the computer processor, cause the computer processor to perform operations comprising:
capturing a target image depicting a scene with the camera assembly of the device;
applying a machine-learning model to the target image to determine a metric relative pose between the target image and a reference image, wherein the metric relative pose represents a transformation from a pose of the reference image to a pose of the target image that is scaled to physical dimensions of the scene;
generating augmented reality content by augmenting the target image with a virtual element scaled according to the physical dimensions of the scene described by the metric relative pose; and
providing the augmented reality content for display on the electronic display of the device.
